(19) United States
(12) Patent Application Publication
(10) Pub. No.: US 2018/0059985 A1
(43) Pub. Date: Mar. 1, 2018

(54) DYNAMIC MANAGEMENT OF RELATIONSHIPS IN DISTRIBUTED OBJECT STORES

(71) Applicant: Intel Corporation, Santa Clara, CA (US)

(72) Inventors: Arun Raghunath, Hillsboro, OR (US); Ian F. Adams, Hillsboro, OR (US); Paul E. Luse, Chandler, AZ (US)

(73) Assignee: Intel Corporation, Santa Clara, CA (US)

(21) Appl. No.: 15/250,808

(22) Filed: Aug. 29, 2016

(51) Int. Cl. G06F 3/06; G06F 1/26; G06F 13/10

(52) U.S. Cl. CPC G06F 3/0647; G06F 3/0611; H04L 67/1097; G06F 1/263; G06F 13/102; G06F 3/067

(57) ABSTRACT

Methods and apparatus related to dynamic management of relationships in distributed object stores are described. In one embodiment, one or more links are generated between two or more objects of the object stores. A single request directed at a first object may return data corresponding to the first object and one or more other objects. Other embodiments are also disclosed and claimed.

### FIELD

The present disclosure generally relates to the field of electronics. More particularly, some embodiments generally relate to a framework for dynamic management of relationships in distributed object stores.

### BACKGROUND

Generally, an object store (or object storage) refers to a storage (or store) organized in accordance with an architecture where this object storage architecture manages data as objects, e.g., as opposed to storage architectures such as file systems (that manage data as a file hierarchy) or block storage (which manages data as blocks). Object storage systems allow relatively inexpensive, scalable and self-healing retention of massive amounts of unstructured data.

Moreover, distributed object stores typically provide relatively simple HTTP (Hyper Text Transfer Protocol) based interfaces such as PUT (or store) and GET (or read) for accessing objects. While this has proven to be a useful building block for larger systems, in isolation it fails to provide any value beyond raw storage capabilities. Consequently, applications using these stores often end up retrieving a large amount of data only to use a small subset of the retrieved data, or end up performing multiple queries to retrieve a set of related data. This in turn may lead to bottlenecks when transferring the data and/or the addition of large latencies.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 3, 4, and 5 illustrate block diagrams of embodiments of computing systems, which may be utilized to implement various embodiments discussed herein.

FIG. 2A illustrates a block diagram of a two-level system main memory, according to an embodiment.

FIG. 2B illustrates a PUT pipeline, according to an embodiment.

FIG. 2C illustrates a GET pipeline, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

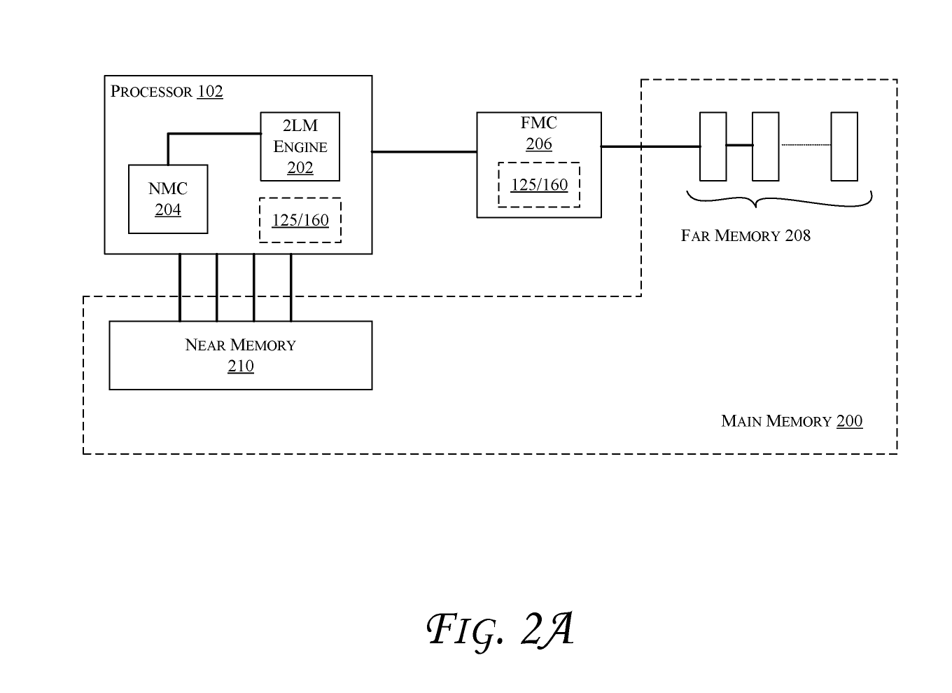

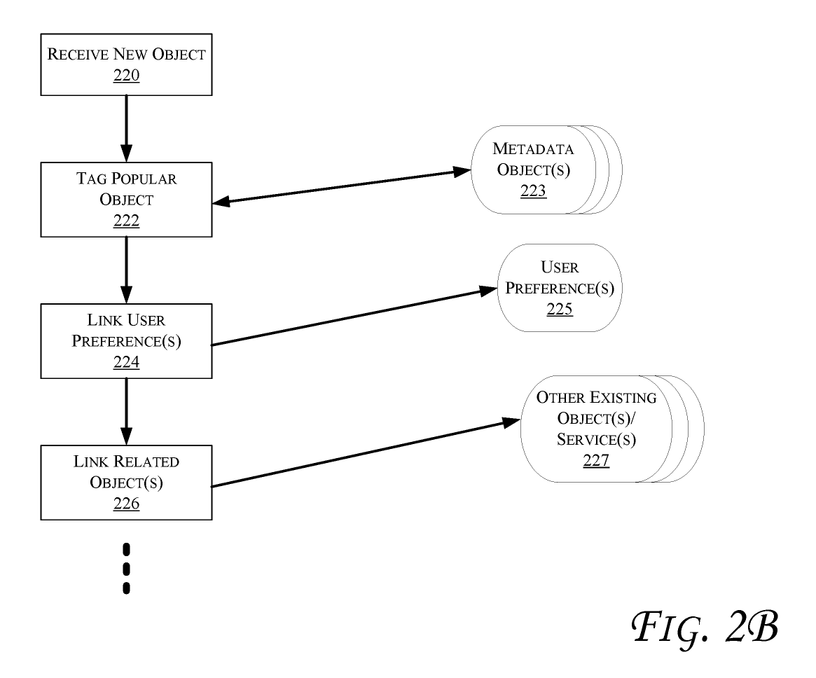

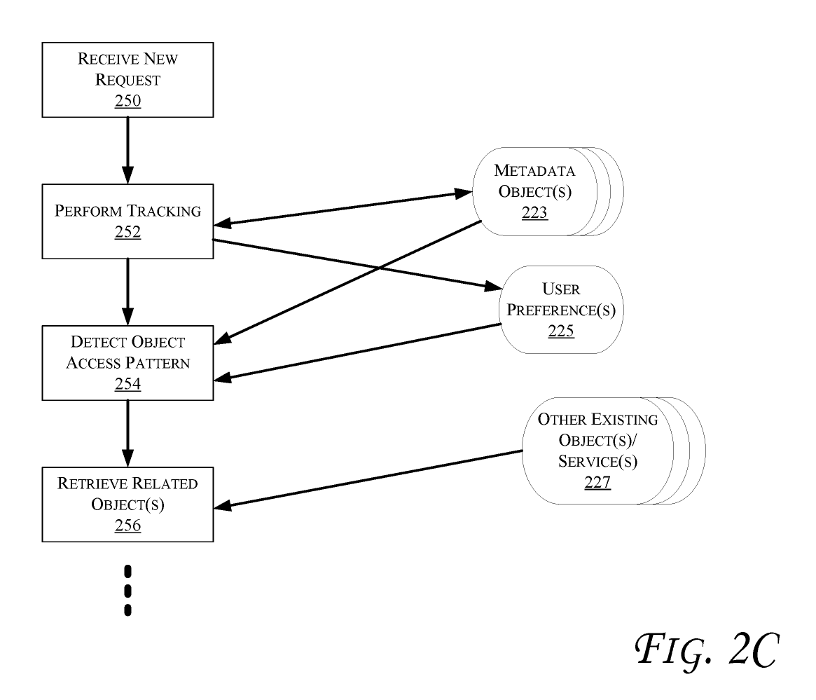

Some embodiments relate to dynamic management of relationships in distributed object stores. The object stores may be distributed across various near (e.g., local) and/or far (e.g., remote) nodes or storage devices, such as discussed with reference to FIG. 2A. As discussed herein, a far node generally refers to a node that is reachable over a network link (or even across one or more network switches or hubs). Also, a node generally refers to computing device (e.g., including a storage device or memory). In an embodiment, logic (e.g., logic 160 shown in the figures) is able to dynamically manage relationships in distributed object stores. Also, while logic 160 is illustrated in various locations in the figures, embodiments are not limited to the locations shown and logic 160 may be provided in other locations.

Furthermore, one or more embodiments discussed herein may be applied to any type of memory including Volatile Memory (VM) and/or Non-Volatile Memory (NVM). Also, embodiments are not limited to a single type of NVM and non-volatile memory of any type or combinations of different NVM types (e.g., including NAND and/or NOR type of memory cells) or other formats usable for memory) may be used. The memory media (whether used in DIMM (Dual Inline Memory Module) format or otherwise) can be any type of memory media including, for example, one or more of: nanowire memory, Ferro-electric Transistor Random Access Memory (FeTRAM), Magnetoresistive Random Access Memory (MRAM), multi-threshold level NAND flash memory, NOR flash memory, Spin Torque Transfer Random Access Memory (STTRAM), Resistive Random Access Memory, byte addressable 3-Dimensional Cross Point Memory, single or multi-level PCM (Phase Change Memory), memory devices that use chalcogenide phase change material (e.g., chalcogenide glass) or “write in place” non-volatile memory. Also, any type of Random Access Memory (RAM) such as Dynamic RAM (DRAM), backed by a power reserve (such as a battery or capacitance) to retain the data, may provide an NV memory solution. Volatile memory can include Synchronous DRAM (SDRAM). Hence, even volatile memory capable of retaining data during power failure or power disruption(s) may be used for memory in various embodiments.

As discussed herein, “metadata” generally refers to attributes or data associated with an object, such as creation time and tags. “Link” generally refers to a reference to another object. Every link may include a tag describing what that object is related to, for example, ‘distance: <50 meters’ might be a link tag key-value. In at least one embodiment, a “link” is a special kind of ‘relationship data’ item that specifically refers to another object within the distributed object store (such as data or metadata); however, other relationship metadata/data may exist that can be used to group like objects together as opposed to specifically linking them. “Data Object” generally refers to a regular object in the storage system. “User Preference Object” generally refers to a special object that is used to store known data about a particular application or user interests or user past requests. “Metadata Object” generally refers to a special object that contains relationship data about a particular tag of interest. For example, it may list all the objects within a particular geographic locale. “Middleware” generally refers to software (or logic) that is implemented in a filter design pattern within the object storage system—i.e. software (or logic) that is executed in the object access path, and based on some criteria, outputs a subset of the input.

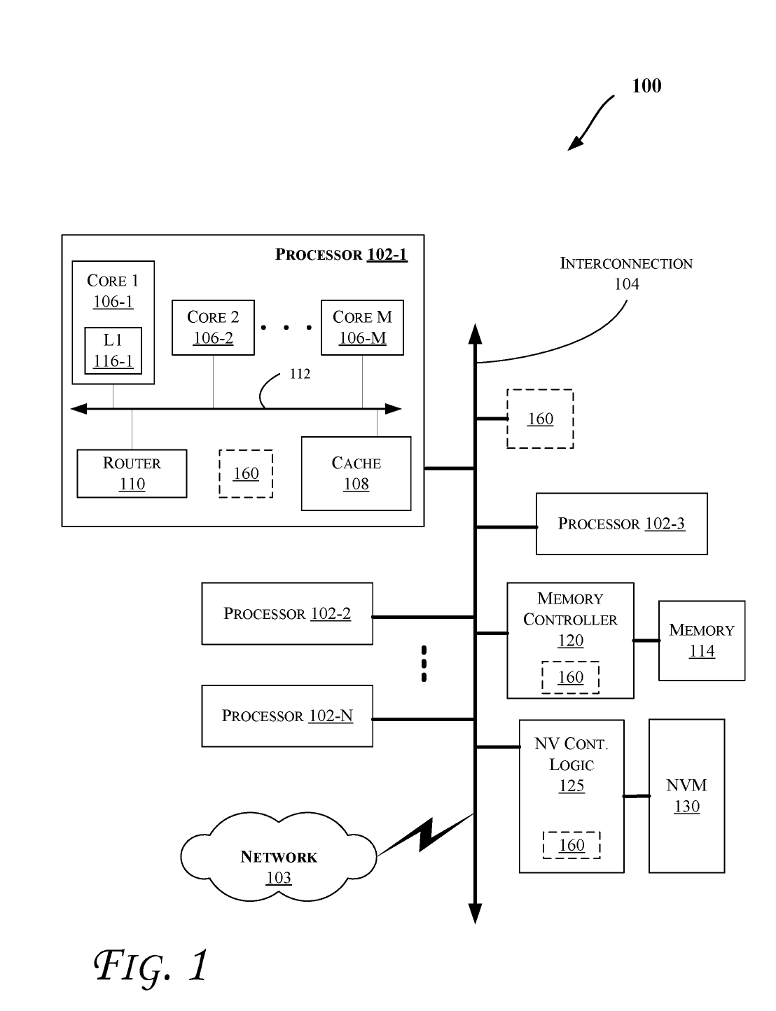

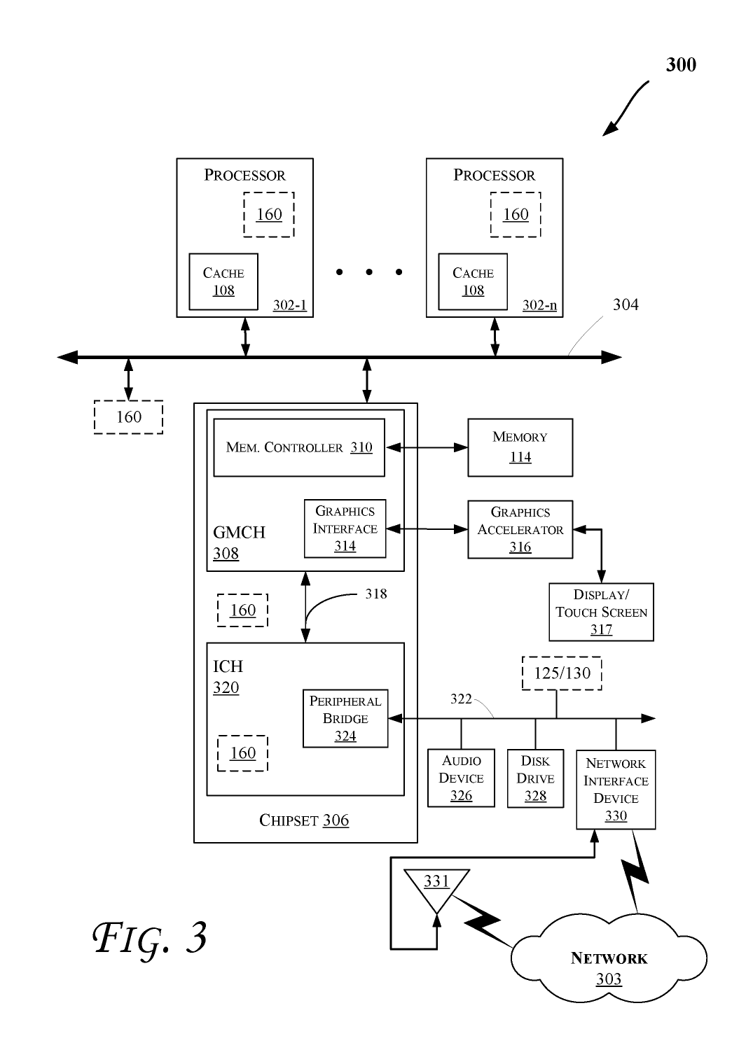

The techniques discussed herein may be provided in various computing systems (e.g., including a non-mobile computing device such as a desktop, workstation, server, rack system, etc. and a mobile computing device such as a smartphone, tablet, UMPC (Ultra-Mobile Personal Computer), laptop computer, Ultrabook™ computing device, smart watch, smart glasses, smart bracelet, etc.), including those discussed with reference to FIGS. 1-5. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may communicate with a network 103 (such as the network 303 of FIG. 3) via an interconnection or bus 104. Network 103 and/or interconnection 104 may provide one or more components of the system 100 with access to distributed object stores, such as those discussed herein with reference to one or more embodiments. Each processor may include various components some of which are only discussed with reference to processor 102-1 for clarity. Accordingly, each of the remaining processors 102-2 through 102-N may include the same or similar components discussed with reference to the processor 102-1.

In an embodiment, the processor 102-1 may include one or more processor cores 106-1 through 106-M (referred to herein as “cores 106,” or more generally as “core 106”), a processor cache 108 (which may be a shared cache or a private cache in various embodiments), and/or a router 110. The processor cores 106 may be implemented on a single integrated circuit (IC) chip. Moreover, the chip may include one or more shared and/or private caches (such as processor cache 108), buses or interconnections (such as a bus or interconnection 112), logic 120, memory controllers (such as those discussed with reference to FIGS. 3-5), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The processor cache 108 may store data (e.g., including instructions) that are utilized by one or more components of the processor 102-1, such as the cores 106. For example, the processor cache 108 may locally cache data stored in a memory 114 for faster access by the components of the processor 102. As shown in FIG. 1, the memory 114 may be in communication with the processors 102 via the interconnection 104. In an embodiment, the processor cache 108 (that may be shared) may have various levels, for example, the processor cache 108 may be a mid-level cache and/or a last-level cache (LLC). Also, each of the cores 106 may include a level 1 (L1) processor cache (116-1) (generally referred to herein as “L1 processor cache 116”). Various components of the processor 102-1 may communicate with the processor cache 108 directly, through a bus (e.g., the bus 112), and/or a memory controller or hub.

As shown in FIG. 1, memory 114 may be coupled to other components of system 100 through a memory controller 120. Memory 114 includes volatile memory and may be interchangeably referred to as main memory. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments.

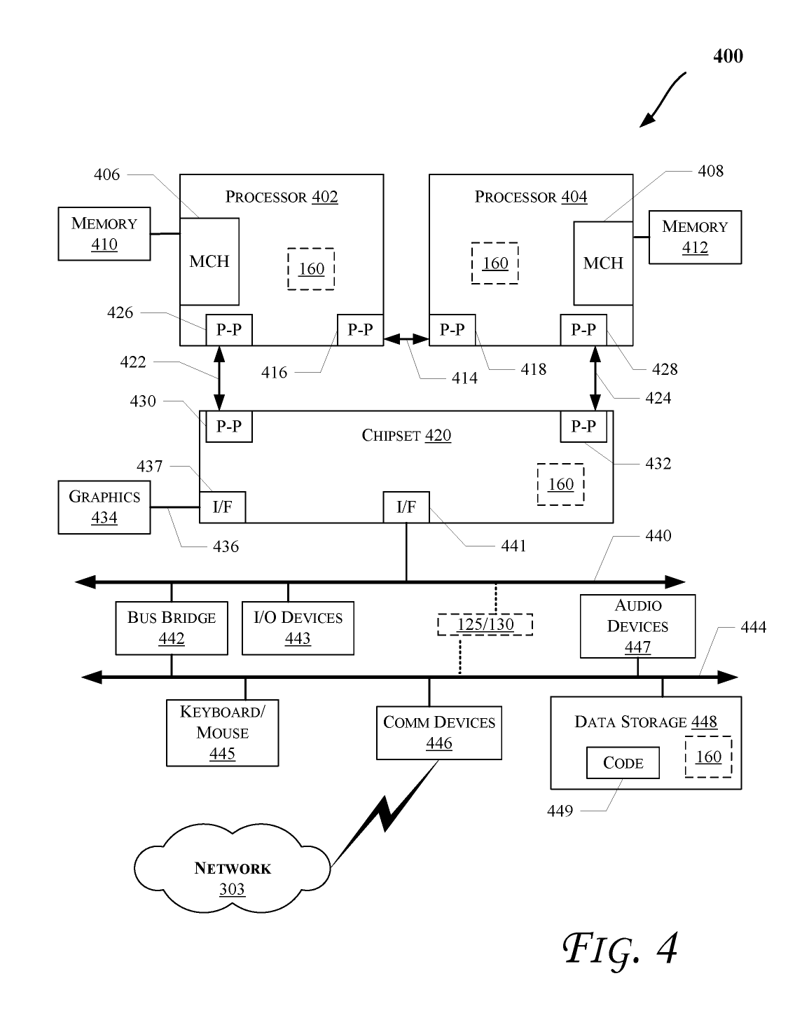

System 100 also includes NV memory 130 (or Non-Volatile Memory (NVM), e.g., compliant with NVMe (NVM express)) coupled to the interconnect 104 via NV controller logic 125. Hence, logic 125 may control access by various components of system 100 to the NVM 130. Furthermore, even though logic 125 is shown to be directly coupled to the interconnection 104 in FIG. 1, logic 125 may communicate via a storage bus/interconnect (such as the SATA (Serial Advanced Technology Attachment) bus, Peripheral Component Interconnect (PCI) (or PCI express (PCIe) interface), etc.) with one or more other components of system 100 (for example where the storage bus is coupled to interconnect 104 via some other logic like a bus bridge, chipset (such as discussed with reference to FIGS. 3, 4, and/or 5), etc.). Additionally, logic 125 may be incorporated into memory controller logic (such as those discussed with reference to FIGS. 3-5) or provided on a same Integrated Circuit (IC) device in various embodiments (e.g., on the same IC device as the NVM 130 or in the same enclosure as the NVM 130). System 100 may also include other types of non-volatile memory such as those discussed with reference to FIGS. 3-5, including for example a hard drive, etc.

FIG. 2A illustrates a block diagram of two-level system main memory, according to an embodiment. Some embodiments are directed towards system main memory 200 comprising two levels of memory (alternatively referred to herein as “2LM”) that include cached subsets of system disk level storage (in addition to, for example, run-time data). This main memory includes a first level memory 210 (alternatively referred to herein as “near memory”) comprising smaller and/or faster memory made of, for example, volatile memory 114 (e.g., including DRAM (Dynamic Random Access Memory)), NVM 130, etc.; and a second level memory 208 (alternatively referred to herein as “far memory”) which comprises larger and/or slower (with respect to the near memory) volatile memory (e.g., memory 114) or nonvolatile memory storage (e.g., NVM 130).

In an embodiment, the far memory is presented as “main memory” to the host Operating System (OS), while the near memory is a cache for the far memory that is transparent to the OS, thus rendering the embodiments described below to appear the same as general main memory solutions. The management of the two-level memory may be done by a combination of logic and modules executed via the host central processing unit (CPU) 102 (which is interchangeably referred to herein as “processor”). Near memory may be coupled to the host system CPU via one or more high bandwidth, low latency links, buses, or interconnects for efficient processing. Far memory may be coupled to the CPU via one or more low bandwidth, high latency links, buses, or interconnects (as compared to that of the near memory).

Referring to FIG. 2A, main memory 200 provides run-time data storage and access to the contents of system disk storage memory (such as disk drive 328 of FIG. 3 or data storage 448 of FIG. 4) to CPU 102. The CPU may include cache memory, which would store a subset of the contents of main memory 200. Far memory may comprise either volatile or nonvolatile memory as discussed herein. In such embodiments, near memory 210 serves a low-latency and high-bandwidth (i.e., for CPU 102 access) cache of far memory 208, which may have considerably lower bandwidth and higher latency (i.e., for CPU 102 access).

In an embodiment, near memory 210 is managed by Near Memory Controller (NMC) 204, while far memory 208 is managed by Far Memory Controller (FMC) 206. FMC 206 reports far memory 208 to the system OS as main memory (i.e., the system OS recognizes the size of far memory 208 as the size of system main memory 200). The system OS and system applications are “unaware” of the existence of near memory 210 as it is a “transparent” cache of far memory 208.

CPU 102 further comprises 2LM engine module/logic 202. The “2LM engine” is a logical construct that may comprise hardware and/or micro-code extensions to support two-level main memory 200. For example, 2LM engine 202 may maintain a full tag table that tracks the status of all architecturally visible elements of far memory 208. For example, when CPU 102 attempts to access a specific data segment in main memory 200, 2LM engine 202 determines whether the data segment is included in near memory 210; if it is not, 2LM engine 202 fetches the data segment in far memory 208 and subsequently writes the data segment to near memory 210 (similar to a cache miss). It is to be understood that, because near memory 210 acts as a “cache” of far memory 208, 2LM engine 202 may further execute data perfecting or similar cache efficiency processes.

Further, 2LM engine 202 may manage other aspects of far memory 208. For example, in embodiments where far memory 208 comprises nonvolatile memory (e.g., NVM 130), it is understood that nonvolatile memory such as flash is subject to degradation of memory segments due to significant reads/writes. Thus, 2LM engine 202 may execute functions including wear-leveling, bad-block avoidance, and the like in a manner transparent to system software. For example, executing wear-leveling logic may include selecting segments from a free pool of clean unmapped segments in far memory 208 that have a relatively low erase cycle count.

In some embodiments, near memory 210 may be smaller in size than far memory 208, although the exact ratio may vary based on, for example, intended system use. In such embodiments, it is to be understood that because far memory 208 may comprise denser and/or cheaper nonvolatile memory, the size of the main memory 200 may be increased cheaply and efficiently and independent of the amount of DRAM (i.e., near memory 210) in the system.

In one embodiment, far memory 208 stores data in compressed form and near memory 210 includes the corresponding uncompressed version. Thus, when near memory 210 request content of far memory 208 (which could be a non-volatile DIMM in an embodiment), FMC 206 retrieves the content and returns it in fixed payload sizes tailored to match the compression algorithm in use (e.g., a 256B transfer).

As mentioned above, distributed object stores (like Swift™, Ceph™, etc.) typically provide basic HTTP (Hyper Text Transfer Protocol) based interfaces (PUT, GET, etc.) for accessing objects. While this has proven to be a useful building block for larger systems, in isolation it does not provide any value beyond basic storage capabilities. As discussed herein, basic storage capability generally refers to the ability to read/write data, as opposed to more advanced capabilities like searching/querying based on some criteria, etc. Consequently, an application using these distributed object stores are often forced to take one of two approaches. In the first approach, the application ends up retrieving a large amount of data only to use a small subset of the data, or ends up performing multiple (e.g., round trip) queries to retrieve a set of related data over a network. This often leads to bottlenecks when transferring data and/or the addition of large latencies to the application. In the other approach, the application relies on external indexing services. For example, external indexing services may create separate indices that enable quick searching of data. While indexing services may aid in search and retrieval, they add overhead in terms of both administrative requirements, as well as additional hardware and/or software infrastructure.

Many object storage systems provide a framework for extensibility through middleware implemented in a filter design pattern. Such middleware may run in the access path of the data (e.g., in docker instances that are run within the distributed store as the request makes its way through the distributed store). The middleware (when presented with a set of input data) may apply some criteria to the input data and only output a subset of the data; hence, filtering the input data. These capabilities enable arbitrary code to run on the data either on its way into the storage system, or on its way out. Typically, middleware may be designed to operate on single objects in isolation, creating/generating and updating metadata for individual objects. For example, if metadata creation is based on single objects only, the system is unable to leverage the ability to create relationships between distinct objects that can assist in filtering unnecessary data in queries, provide additional context, or related data that would be typically requested by the user. This leads to transferring large amounts of data unnecessarily and is inefficient as it slows down the response from the store.

By contrast, some embodiments can extend these frameworks, e.g., by creating/generating dynamic links across objects. More specifically, some embodiments dynamically tag objects with application specific metadata (for example geographic location, sensor calibration values, etc.), as well as provide semantic links between objects. For instance, one embodiment of rich metadata could be counters that track access patterns for an object. Another embodiment involves creation of distinct metadata objects containing information that ‘links’ semantically related objects, based on criteria like location, cuisine, popularity etc. This brings greater functionality to the storage system itself by enabling intelligent prefetching and/or association of related objects; more intelligent means that the system is able to efficiently select, or predict, upcoming requests and have that data available before it is actually requested. This allows applications or end-users to use a single storage solution to (e.g., automatically) categorize as well as retrieve and/or prefetch/cache related data (e.g., across multiple objects) based on a single object retrieval request. For example, if the object metadata reveals an access pattern where restaurant object access is repeatedly followed by accesses to map directions and traffic information, the map and traffic data could be pre-fetched (or returned as additional ‘relevant related data’ right when a restaurant object is retrieved. In an embodiment, the returned data may be cached in any of the storage discussed herein, e.g., discussed with reference to FIGS. 1-2 and 3-5.

At least some embodiments provide one or more of the following: (1) tagging and/or linking objects to one another when the objects are uploaded; and/or (2) tracking object retrievals historically, e.g., such that a single object retrieval request can efficiently cause retrieval and/or filtering of multiple related data objects without needing multiple distinct object queries or transferring large amounts of (e.g., potentially irrelevant/unrelated) data. Moreover, types of information for (1) and (2) may include one or more of: statistics on accesses to an individual object (e.g., number of accesses, access frequency, access patterns like periodic requests every hour, day, week, etc.); and/or inter-relationships/linking between accesses to “distinct” objects (e.g., every time object A is accessed, it is followed by an access to object B. Such information is tracked and used to pre-fetch objects). Hence, an embodiment includes logic to analyze accesses to (e.g., all) objects to derive object relationships without any explicit user input.

One or more embodiments provide a pipeline framework for managing and/or generating metadata and/or relational links between data objects inside of an object store to enable intelligent retrieval, prefetching, and/or caching of data objects. To enable this functionality, two separate pipeline frameworks may be used in some embodiments, one for the uploading/writing/storing (PUT) of data, and one for retrieval/reading of data (GET). Each pipeline may contain one or more arbitrary middleware components to act upon objects, or to communicate outside of the system (e.g., to raise an alert) as they are uploaded and downloaded in the system.

FIG. 2B illustrates a PUT pipeline, according to an embodiment. The PUT pipeline may include a series/succession of one or more middleware components that identify and create relationships between data objects in the system. After a new object is input/received 220, each middleware may tag (222) and/or update links to and from objects (224/226), information within metadata objects 223, and/or user preference(s) 225. It may be assumed that other existing objects/services (227) can embed or add data about user preferences in object requests (e.g., Openstack™ Swift headers allow arbitrary key-value pairs to be inserted into a request environment). This is reasonable given the plethora of easily obtainable and actively mined data in many systems (e.g., through social media, etc.).

FIG. 2C illustrates a GET pipeline, according to an embodiment. The GET pipeline is similarly a series of one or more middleware components to run in succession/series. After receiving a new request 250, there are two key operations that the GET pipeline should trigger: history tracking 252, and related object collation (including detecting/determining object access pattern 254 and retrieving related objects 256). The first operation 252 utilizes middleware in the GET pipeline and can update metadata 223. In an embodiment, operation 252 may also cause updating of user preference objects 225 (which may be more generically referred to as metadata objects), e.g., to note the nature of a request, and what object(s) are going to be retrieved. Operations 252 and/or 254 may update or access counters, last-access times, etc. Secondly, the middleware may follow links to related objects (e.g., recall on upload, object relations were determined by the PUT pipeline, etc.) for retrieval and filtering at operation 256.

As a practical example for object input, consider a restaurant finding application. At a high level, it needs to help users find information about restaurants they might like to eat at. This includes information about how to locate the restaurant, how popular it is (or might be), what the restaurant serves, and how to get there.

Referring to FIG. 2B as a guide, when an object with information about a new chain restaurant is uploaded 202, middleware in the pipeline checks against the metadata objects 223 to determine if there are other branches of that restaurant already stored, as a mark of whether or not it is a popular type of restaurant in the area (for example, many branches of the same chain mean its likely popular in the area). If it is, the metadata object may be updated 222 to include another restaurant flagged as popular. The user preferences middleware may extract user/application provided information on the request about the type of user likely to prefer this restaurant. Finally, the linking middleware 224/226 may (e.g., with the information gathered from the prior middleware, as well as any inbuilt analysis of its own (recall middleware may be custom built and can function as an arbitrary program)) add direct references to and from other objects. For example, it may extract the cuisine of the new restaurant and add a link to this restaurant object in a metadata object that lists all restaurants offering that cuisine. This allows a subsequent query for restaurants offering that cuisine to simply refer to the metadata object and return the results.

Referring to FIG. 2C, as an example of how the GET pipeline (for object retrieval) may function, the example of a restaurant finding application can again be used. In an embodiment, it is assumed that the received request 250 includes the user ID (identifier). The request tracking code middleware 252 updates meta information 223 about who requested the object. This allows learning, for example, that the user likes the particular cuisine offered by the restaurant. This ‘learned’ information can be stored in the user preferences metadata object 225. The object access pattern detection middleware 254 collects meta information about the object across all users. For example, the number of requests for a particular restaurant object can be used to gauge the popularity of the restaurant.

The related object retrieval middleware 256 utilizes the user identifier (ID) from the request to generate internal queries which provides the middleware information about relevant related object information 227 that could be sent with the originally requested object. For example, if the preferences reveal that the user prefers public transport, the response can include information about bus schedules. For another user that prefers driving, the same request would cause the middleware to include driving directions, parking information, and/or traffic information in the response. This middleware may also utilize the information generated by the other middleware. For example, it can find other restaurants nearby that offer the user's preferred cuisine or include information about other popular restaurants nearby in the response to the original request.

Accordingly, current object storage systems may be exposed as simple key-value stores of data and metadata, abstracting the data placement and durability/availability management away from the users. They do not, however, offer any functionality beyond basic storage. To intelligently gather multiple objects, explicit input is used from a variety of sources, such as external indexing services, NoSQL (or Non SQL (Structured Query Language)) stores, etc. By contrast, at least one embodiment incorporates processing and intelligence within the object storage system (e.g., via logic 160) to offer greater value to applications with explicit or implicit retrieval of related data objects. This reduces access latencies, improves scalability, and/or reduces management overhead as administrators and designers have a unified framework to work within.

More specifically, one or more embodiments enable numerous capabilities and optimizations that are currently not available using an object store in isolation, including one or more of:
(i) returning more than one related data objects in response to a single request for an object;
(ii) improve access latency of subsequent object requests by pre-caching within the storage system objects that are related, and likely to be requested subsequently—potentially based on intelligence gathered within the storage system of application/user behavior;
(iii) return different sets of related objects for a given query, for example, depending on user preferences—the results of an internal query on user preferences initiated in a middleware in response to an external object retrieval request by a particular user, can cause a very different object set returned by the storage system than a different user;
(iv) filter a large data set within the storage system itself, reducing/avoiding transfer of large amounts of data that may be irrelevant to the querying application—e.g., multiple days of video could be filtered down to a few minutes of relevant clips containing the subject of interest, say a particular face;
(v) create separate metadata objects with links to the actual data stored in the storage system, such that a subsequent query only needs to consult the metadata object and follow the links to return the results relevant for a given query, all executed within the object store. This may be considered to be similar to optimizations done by some stores and independent search indices, but without the need to coordinate multiple islands of systems.

Hence, some embodiments differ from experimental semantic file systems, because their primary target is improving file system search through the use of transducers (roughly analogous to the filter middleware) that crawl the file system and analyze and index files.

FIG. 3 illustrates a block diagram of a computing system 300 in accordance with an embodiment. The computing system 300 may include one or more central processing unit(s) (CPUs) 302 or processors that communicate via an interconnection network (or bus) 304. The processors 302 may include a general purpose processor, a network processor (that processes data communicated over a computer network 303), an application processor (such as those used in cell phones, smart phones, etc.), or other types of a processor (including a reduced instruction set computer (RISC) processor or a complex instruction set computer (CISC)).

Various types of computer networks 303 may be utilized including wired (e.g., Ethernet, Gigabit, Fiber, etc.) or wireless networks (such as cellular, including 3G (Third-Generation Cell-Phone Technology or 3rd Generation Wireless Format (UWCC)), 4G (Fourth-Generation Cell-Phone Technology), 4G Advanced, Low Power Embedded (LPE), Long Term Evolution (LTE), LTE advanced, etc.). Moreover, the processors 302 may have a single or multiple core design. The processors 302 with a multiple core design may integrate different types of processor cores on the same integrated circuit (IC) die. Also, the processors 302 with a multiple core design may be implemented as symmetrical or asymmetrical multiprocessors.

In an embodiment, one or more of the processors 302 may be the same or similar to the processors 102 of FIG. 1. For example, one or more of the processors 302 may include one or more of the cores 106 and/or processor cache 108. Also, the operations discussed with reference to FIGS. 1-2C may be performed by one or more components of the system 300.

A chipset 306 may also communicate with the interconnection network 304. The chipset 306 may include a graphics and memory control hub (GMCH) 308. The GMCH 308 may include a memory controller 310 (which may be the same or similar to the memory controller 120 of FIG. 1 in an embodiment) that communicates with the memory 114. The memory 114 may store data, including sequences of instructions that are executed by the CPU 302, or any other device included in the computing system 300. Also, system 300 includes logic 125/160 and/or NVM 130 in various locations such as shown or not shown. In one embodiment, the memory 114 may include one or more volatile memory devices such as random access memory (RAM), dynamic RAM (DRAM), synchronous DRAM (SDRAM), static RAM (SRAM), or other types of memory devices. Nonvolatile memory may also be utilized such as a hard disk drive, flash, etc., including any NVM discussed herein. Additional devices may communicate via the interconnection network 304, such as multiple CPUs and/or multiple system memories.

The GMCH 308 may also include a graphics interface 314 that communicates with a graphics accelerator 316. In one embodiment, the graphics interface 314 may communicate with the graphics accelerator 316 via an accelerated graphics port (AGP) or Peripheral Component Interconnect (PCI) (or PCI express (PCIe) interface). In an embodiment, a display 317 (such as a flat panel display, touch screen, etc.) may communicate with the graphics interface 314 through, for example, a signal converter that translates a digital representation of an image stored in a memory device such as video memory or system memory into display signals that are interpreted and displayed by the display. The display signals produced by the display device may pass through various control devices before being interpreted by and subsequently displayed on the display 317.

A hub interface 318 may allow the GMCH 308 and an input/output control hub (ICH) 320 to communicate. The ICH 320 may provide an interface to I/O devices that communicate with the computing system 300. The ICH 320 may communicate with a bus 322 through a peripheral bridge (or controller) 324, such as a peripheral component interconnect (PCI) bridge, a universal serial bus (USB) controller, or other types of peripheral bridges or controllers. The bridge 324 may provide a data path between the CPU 302 and peripheral devices. Other types of topologies may be utilized. Also, multiple buses may communicate with the ICH 320, e.g., through multiple bridges or controllers. Moreover, other peripherals in communication with the ICH 320 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 322 may communicate with an audio device 326, one or more disk drive(s) 328, and a network interface device 330 (which is in communication with the computer network 303, e.g., via a wired or wireless interface). As shown, the network interface device 330 may be coupled to an antenna 331 to wirelessly (e.g., via an Institute of Electrical and Electronics Engineers (IEEE) 802.11 interface (including IEEE 802.11a/b/g/n/ac, etc.), cellular interface, 3G, 4G, LPE, etc.) communicate with the network 303. Other devices may communicate via the bus 322. Also, various components (such as the network interface device 330) may communicate with the GMCH 308 in some embodiments. In addition, the processor 302 and the GMCH 308 may be combined to form a single chip. Furthermore, the graphics accelerator 316 may be included within the GMCH 308 in other embodiments.

Furthermore, the computing system 300 may include volatile and/or nonvolatile memory. For example, nonvolatile memory may include one or more of the following: read-only memory (ROM), programmable ROM (PROM), erasable PROM (EPROM), electrically EPROM (EEPROM), a disk drive (e.g., 328), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 4 illustrates a computing system 400 that is arranged in a point-to-point (PtP) configuration, according to an embodiment. In particular, FIG. 4 shows a system where processors, memory, and input/output devices are interconnected by a number of point-to-point interfaces. The operations discussed with reference to FIGS. 1-3 may be performed by one or more components of the system 400.

As illustrated in FIG. 4, the system 400 may include several processors, of which only two, processors 402 and 404 are shown for clarity. The processors 402 and 404 may each include a local memory controller hub (MCH) 406 and 408 to enable communication with memories 410 and 412. The memories 410 and/or 412 may store various data such as those discussed with reference to the memory 114 of FIGS. 1 and/or 3. Also, MCH 406 and 408 may include the memory controller 120 in some embodiments. Furthermore, system 400 includes logic 125/160 and/or NVM 130 in various locations such as shown or not shown. The logic 125/160 and/or NVM 130 may be coupled to system 400 via bus 440 or 444, via other point-to-point connections to the processor(s) 402 or 404 or chipset 420, etc. in various embodiments.

In an embodiment, the processors 402 and 404 may be one of the processors 302 discussed with reference to FIG. 3. The processors 402 and 404 may exchange data via a point-to-point (PtP) interface 414 using PtP interface circuits 416 and 418, respectively. Also, the processors 402 and 404 may each exchange data with a chipset 420 via individual PtP interfaces 422 and 424 using point-to-point interface circuits 426, 428, 430, and 432. The chipset 420 may further exchange data with a high-performance graphics circuit 434 via a high-performance graphics interface 436, e.g., using a PtP interface circuit 437. As discussed with reference to FIG. 3, the graphics interface 436 may be coupled to a display device (e.g., display 317) in some embodiments.

In one embodiment, one or more of the cores 106 and/or processor cache 108 of FIG. 1 may be located within the processors 402 and 404 (not shown). Other embodiments, however, may exist in other circuits, logic units, or devices within the system 400 of FIG. 4. Furthermore, other embodiments may be distributed throughout several circuits, logic units, or devices illustrated in FIG. 4.

The chipset 420 may communicate with a bus 440 using a PtP interface circuit 441. The bus 440 may have one or more devices that communicate with it, such as a bus bridge 442 and I/O devices 443. Via a bus 444, the bus bridge 442 may communicate with other devices such as a keyboard/mouse 445, communication devices 446 (such as modems, network interface devices, or other communication devices that may communicate with the computer network 303, as discussed with reference to network interface device 330 for example, including via antenna 331), audio I/O device, and/or a data storage device 448. The data storage device 448 may store code 449 that may be executed by the processors 402 and/or 404.

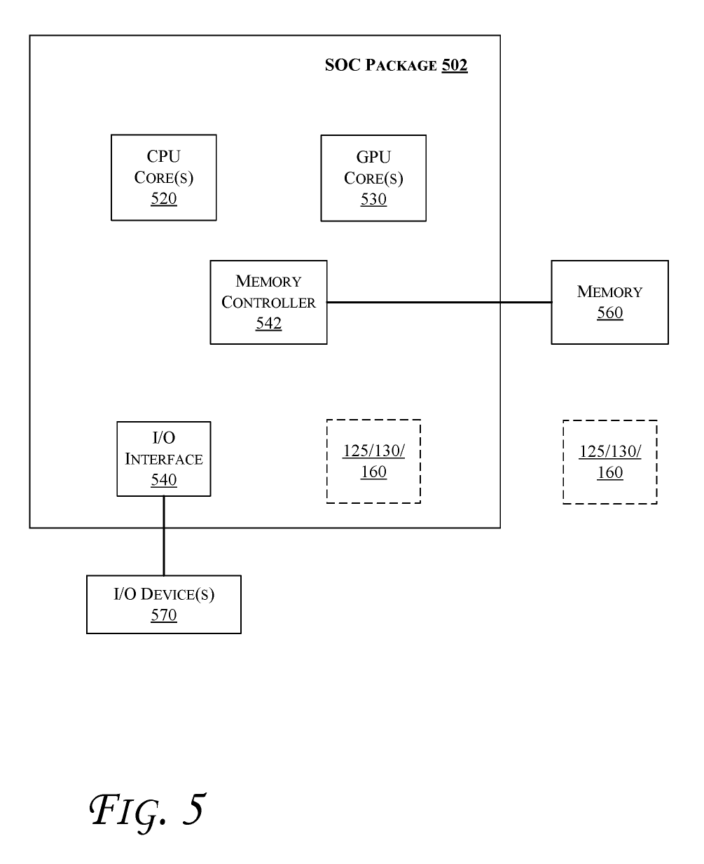

In some embodiments, one or more of the components discussed herein can be embodied as a System On Chip (SOC) device. FIG. 5 illustrates a block diagram of an SOC package in accordance with an embodiment. As illustrated in FIG. 5, SOC 502 includes one or more Central Processing Unit (CPU) cores 520, one or more Graphics Processor Unit (GPU) cores 530, an Input/Output (I/O) interface 540, and a memory controller 542. Various components of the SOC package 502 may be coupled to an interconnect or bus such as discussed herein with reference to the other figures. Also, the SOC package 502 may include more or less components, such as those discussed herein with reference to the other figures. Further, each component of the SOC package 520 may include one or more other components, e.g., as discussed with reference to the other figures herein. In one embodiment, SOC package 502 (and its components) is provided on one or more Integrated Circuit (IC) die, e.g., which are packaged onto a single semiconductor device.

As illustrated in FIG. 5, SOC package 502 is coupled to a memory 560 (which may be similar to or the same as memory discussed herein with reference to the other figures) via the memory controller 542. In an embodiment, the memory 560 (or a portion of it) can be integrated on the SOC package 502.

The I/O interface 540 may be coupled to one or more I/O devices 570, e.g., via an interconnect and/or bus such as discussed herein with reference to other figures. I/O device(s) 570 may include one or more of a keyboard, a mouse, a touchpad, a display, an image/video capture device (such as a camera or camcorder/video recorder), a touch screen, a speaker, or the like. Furthermore, SOC package 502 may include/integrate items 125, 130, and/or 160 in an embodiment. Alternatively, items 125, 130, and/or 160 may be provided outside of the SOC package 502 (i.e., as a discrete logic).

Embodiments described herein can be powered by a battery, wireless charging, a renewal energy source (e.g., solar power or motion-based charging), or when connected to a charging port or wall outlet.

The following examples pertain to further embodiments. Example 1 may optionally include an apparatus comprising: memory to store data corresponding to object stores; and logic, coupled to the memory, to generate one or more links between two or more objects of the object stores, wherein a request corresponding to a first object of the object stores is to cause provision of data corresponding to the first object and a second object of the object stores based at least in part on the one or more generated links. Example 2 may optionally include the apparatus of example 1, wherein the logic is to generate the one or more links for an object in response to uploading of the object to the object stores. Example 3 may optionally include the apparatus of example 1, comprising logic to track retrieval history of an object from the object stores or inter-relationships between accesses to distinct objects. Example 4 may optionally include the apparatus of example 1, comprising logic to tag at least one object in the object stores or generate one or more new metadata objects that link objects based on one or more properties. Example 5 may optionally include the apparatus of example 1, wherein the request is a PUT request or a GET request. Example 6 may optionally include the apparatus of example 1, wherein the request is to cause provision of data corresponding to a plurality of objects from the object stores, wherein the one or more links are to be used for caching, prefetching, or returning of related information. Example 7 may optionally include the apparatus of example 1, wherein the request is to cause provision of the data without multiple distinct object queries or transferring large amounts of unrelated data from the object stores. Example 8 may optionally include the apparatus of example 1, wherein the request is to comprise a user identifier. Example 9 may optionally include the apparatus of example 1, wherein the provided data is to be cached. Example 10 may optionally include the apparatus of example 1, wherein the object stores are to be distributed across a plurality of storage nodes. Example 11 may optionally include the apparatus of example 10, wherein the plurality of storage nodes is to comprise a near storage node and/or a far storage node. Example 12 may optionally include the apparatus of example 1, wherein the memory is to comprise one or more of: volatile memory and non-volatile memory. Example 13 may optionally include the apparatus of example 1, wherein the memory is to comprise one or more of: nanowire memory, Ferro-electric Transistor Random Access Memory (FeTRAM), Magnetoresistive Random Access Memory (MRAM), flash memory, Spin Torque Transfer Random Access Memory (STTRAM), Resistive Random Access Memory, byte addressable 3-Dimensional Cross Point Memory, PCM (Phase Change Memory), write-in-place non-volatile memory, and volatile memory backed by a power reserve to retain data during power failure or power disruption. Example 14 may optionally include the apparatus of example 1, further comprising one or more of: at least one processor, having one or more processor cores, communicatively coupled to the memory, a battery communicatively coupled to the apparatus, or a network interface communicatively coupled to the apparatus.

Example 15 may optionally include a method comprising: storing data corresponding to object stores in memory; and generating one or more links between two or more objects of the object stores, wherein a request corresponding to a first object of the object stores causes provision of data corresponding to the first object and a second object of the object stores based at least in part on the one or more generated links. Example 16 may optionally include the method of example 15, further comprising generating the one or more links for an object in response to uploading of the object to the object stores. Example 17 may optionally include the method of example 15, further comprising tracking retrieval history of an object from the object stores or inter-relationships between accesses to distinct objects. Example 18 may optionally include the method of example 15, further comprising tagging at least one object in the object stores or generating one or more new metadata objects that link objects based on one or more properties. Example 19 may optionally include the method of example 15, wherein the request is a PUT request or a GET request. Example 20 may optionally include the method of example 15, further comprising the request causing provision of data corresponding to a plurality of objects from the object stores, wherein the one or more links are to be used for caching, prefetching, or returning of related information. Example 21 may optionally include the method of example 15, further comprising the request causing provision of the data without multiple distinct object queries or transferring large amounts of unrelated data from the object stores. Example 22 may optionally include the method of example 15, further comprising caching the provided data.

Example 23 may optionally include one or more computer-readable medium comprising one or more instructions that when executed on at least one processor configure the at least one processor to perform one or more operations to: store data corresponding to object stores in memory; and generate one or more links between two or more objects of the object stores, wherein a request corresponding to a first object of the object stores causes provision of data corresponding to the first object and a second object of the object stores based at least in part on the one or more generated links. Example 24 may optionally include the one or more computer-readable medium of example 23, further comprising one or more instructions that when executed on the processor configure the processor to perform one or more operations to track retrieval history of an object from the object stores or inter-relationships between accesses to distinct objects. Example 25 may optionally include the one or more computer-readable medium of example 23, further comprising one or more instructions that when executed on the processor configure the processor to perform one or more operations to tag at least one object in the object stores or generate one or more new metadata objects that link objects based on one or more properties.

Example 26 may optionally include a computing system comprising: a processor; memory, coupled to the processor, to store data corresponding to object stores; and logic, coupled to the memory, to generate one or more links between two or more objects of the object stores, wherein a request corresponding to a first object of the object stores is to cause provision of data corresponding to the first object and a second object of the object stores based at least in part on the one or more generated links. Example 27 may optionally include the system of example 26, wherein the logic is to generate the one or more links for an object in response to uploading of the object to the object stores. Example 28 may optionally include the system of example 26, comprising logic to track retrieval history of an object from the object stores or inter-relationships between accesses to distinct objects. Example 29 may optionally include the system of example 26, comprising logic to tag at least one object in the object stores or generate one or more new metadata objects that link objects based on one or more properties. Example 30 may optionally include the system of example 26, wherein the request is a PUT request or a GET request. Example 31 may optionally include the system of example 26, wherein the request is to cause provision of data corresponding to a plurality of objects from the object stores, wherein the one or more links are to be used for caching, prefetching, or returning of related information. Example 32 may optionally include the system of example 26, wherein the request is to cause provision of the data without multiple distinct object queries or transferring large amounts of unrelated data from the object stores. Example 33 may optionally include the system of example 26, wherein the request is to comprise a user identifier. Example 34 may optionally include the system of example 26, wherein the provided data is to be cached. Example 35 may optionally include the system of example 26, wherein the object stores are to be distributed across a plurality of storage nodes. Example 36 may optionally include the system of example 35, wherein the plurality of storage nodes is to comprise a near storage node and/or a far storage node. Example 37 may optionally include the system of example 26, wherein the memory is to comprise one or more of: volatile memory and non-volatile memory. Example 38 may optionally include the system of example 26, wherein the memory is to comprise one or more of: nanowire memory, Ferro-electric Transistor Random Access Memory (FeTRAM), Magnetoresistive Random Access Memory (MRAM), flash memory, Spin Torque Transfer Random Access Memory (STTRAM), Resistive Random Access Memory, byte addressable 3-Dimensional Cross Point Memory, PCM (Phase Change Memory), write-in-place non-volatile memory, and volatile memory backed by a power reserve to retain data during power failure or power disruption. Example 39 may optionally include the system of example 26, further comprising one or more of: the processor, having one or more processor cores, communicatively coupled to the memory, a battery communicatively coupled to the apparatus, or a network interface communicatively coupled to the apparatus.

Example 40 may optionally include an apparatus comprising means to perform a method as set forth in any preceding example. Example 41 comprises machine-readable storage including machine-readable instructions, when executed, to implement a method or realize an apparatus as set forth in any preceding example.

In various embodiments, the operations discussed herein, e.g., with reference to FIGS. 1-5, may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a memory device such as those discussed with respect to FIGS. 1-5.

Additionally, such tangible computer-readable media may be downloaded as a computer program product, wherein the program may be transferred from a remote computer (e.g., a server) to a requesting computer (e.g., a client) by way of data signals (such as in a carrier wave or other propagation medium) via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features, numerical values, and/or methodological acts, it is to be understood that claimed subject matter may not be limited to the specific features, numerical values, or acts described. Rather, the specific features, numerical values, and acts are disclosed as sample forms of implementing the claimed subject matter.

1. An apparatus comprising:
memory to store data corresponding to object stores; and
logic, coupled to the memory, to generate one or more links between two or more objects of the object stores,
wherein a request corresponding to a first object of the object stores is to cause provision of data corresponding to the first object and a second object of the object stores based at least in part on the one or more generated links.

2. The apparatus of claim 1, wherein the logic is to generate the one or more links for an object in response to uploading of the object to the object stores.

3. The apparatus of claim 1, comprising logic to track retrieval history of an object from the object stores or inter-relationships between accesses to distinct objects.

4. The apparatus of claim 1, comprising logic to tag at least one object in the object stores or generate one or more new metadata objects that link objects based on one or more properties.

5. The apparatus of claim 1, wherein the request is a PUT request or a GET request.

6. The apparatus of claim 1, wherein the request is to cause provision of data corresponding to a plurality of objects from the object stores, wherein the one or more links are to be used for caching, prefetching, or returning of related information.

7. The apparatus of claim 1, wherein the request is to cause provision of the data without multiple distinct object queries or transferring large amounts of unrelated data from the object stores.

8. The apparatus of claim 1, wherein the request is to comprise a user identifier.

9. The apparatus of claim 1, wherein the provided data is to be cached.

10. The apparatus of claim 1, wherein the object stores are to be distributed across a plurality of storage nodes.

11. The apparatus of claim 10, wherein the plurality of storage nodes is to comprise a near storage node and/or a far storage node.

12. The apparatus of claim 1, wherein the memory is to comprise one or more of: volatile memory and non-volatile memory.

13. The apparatus of claim 1, wherein the memory is to comprise one or more of:
nanowire memory, Ferro-electric Transistor Random Access Memory (FeTRAM), Magnetoresistive Random Access Memory (MRAM), flash memory, Spin Torque Transfer Random Access Memory (STTRAM), Resistive Random Access Memory, byte addressable 3-Dimensional Cross Point Memory, PCM (Phase Change Memory), write-in-place non-volatile memory, and volatile memory backed by a power reserve to retain data during power failure or power disruption.

14. The apparatus of claim 1, further comprising one or more of: at least one processor, having one or more processor cores, communicatively coupled to the memory, a battery communicatively coupled to the apparatus, or a network interface communicatively coupled to the apparatus.

15. A method comprising:
storing data corresponding to object stores in memory; and
generating one or more links between two or more objects of the object stores,
wherein a request corresponding to a first object of the object stores causes provision of data corresponding to the first object and a second object of the object stores based at least in part on the one or more generated links.

16. The method of claim 15, further comprising generating the one or more links for an object in response to uploading of the object to the object stores.

17. The method of claim 15, further comprising tracking retrieval history of an object from the object stores or inter-relationships between accesses to distinct objects.

18. The method of claim 15, further comprising tagging at least one object in the object stores or generating one or more new metadata objects that link objects based on one or more properties.

19. The method of claim 15, wherein the request is a PUT request or a GET request.

20. The method of claim 15, further comprising the request causing provision of data corresponding to a plurality of objects from the object stores, wherein the one or more links are to be used for caching, prefetching, or returning of related information.

21. The method of claim 15, further comprising the request causing provision of the data without multiple distinct object queries or transferring large amounts of unrelated data from the object stores.

22. The method of claim 15, further comprising caching the provided data.

23. One or more computer-readable medium comprising one or more instructions that when executed on at least one processor configure the at least one processor to perform one or more operations to:
store data corresponding to object stores in memory; and
generate one or more links between two or more objects of the object stores,
wherein a request corresponding to a first object of the object stores causes provision of data corresponding to the first object and a second object of the object stores based at least in part on the one or more generated links.

24. The one or more computer-readable medium of claim 23, further comprising one or more instructions that when executed on the processor configure the processor to perform one or more operations to track retrieval history of an object from the object stores or inter-relationships between accesses to distinct objects.

25. The one or more computer-readable medium of claim 23, further comprising one or more instructions that when executed on the processor configure the processor to perform one or more operations to tag at least one object in the object stores or generate one or more new metadata objects that link objects based on one or more properties.
